(19) United States
(12) Patent Application Publication
(10) Pub. No.: US 2014/0299424 A1
(43) Pub. Date: Oct. 9, 2014

(54) DISC BRAKE DEVICE

(71) Applicant: ADVICS CO., LTD., Kariya-city (JP)

(72) Inventor: Shohei ARAKANE, Aichi-ken (JP)

(73) Assignee: ADVICS CO., LTD., Kariya-city (JP)

(21) Appl. No.: 14/228,586

(22) Filed: Mar. 28, 2014

(30) Foreign Application Priority Data
Mar. 28, 2013 (JP) 2013-068039

(51) Int. Cl. F16D 65/095; F16D 65/00

(52) U.S. Cl. CPC F16D 65/095; F16D 65/0068
USPC 188/73.32

(57) ABSTRACT

A disc brake device includes: a disc rotor assembled to a rotating body; a caliper assembled to a supporting member so as to straddle an outer periphery of part of the disc rotor; a pair of brake pads disposed so as to clamp the disc rotor; pistons disposed in a caliper to press the brake pads; a supporting shaft inserted into a supporting portion provided on the caliper to support the respective brake pads so as to be movable in a rotor axis direction; and a retaining member inserted into a through hole provided at one end of the supporting shaft to prevent the supporting shaft from coming apart from the supporting portion of the caliper. The retaining member includes a head portion configured to engage with one of opening portions of the through hole, and a pair of leg portions to be inserted into the through hole, and at least one of a pair of the leg portions is bent, and includes a barb shape configured to engage with the other opening portion of the through hole.

### TECHNOLOGICAL FIELD

The present invention relates to a disc brake device used in vehicles and, more specifically, to a disc brake device in which a pair of brake pads are supported by an inner periphery supporting shaft and an outer periphery supporting shaft so as to be movable in a direction of axis of a disc rotor.

### BACKGROUND DISCUSSION

A disc brake device of this type is described, for example, in JP-A-2010-236611 and JP-A-2011-241951. The disc brake device disclosed in these documents includes a disc rotor assembled to a rotating body (for example, an axle hub) and configured to rotate integrally with the rotating body; a caliper assembled to a supporting member (for example, a vehicle body) so as to straddle an outer periphery of part of the disc rotor; a pair of brake pads disposed so as to be capable of clamping the disc rotor and supported on the caliper via supporting shafts so as to be movable in the rotor axis direction; and pistons disposed in the caliper and configured to press the respective brake pads toward the disc rotor, and is configured in such a manner that the piston presses back plates of the respective brake pads, whereby linings of the respective brake pads come into press contact with surfaces to be braked of the disc rotor so as to be slidable to put a brake on the disc rotor.

The respective brake pads are biased inward in the rotor radial direction by a biasing member, and the supporting shaft includes a single inner periphery supporting shaft configured to engage a V-shaped inner peripheral side torque receiving surfaces provided on the respective back plates at positions inside the respective linings in the rotor radial direction and at center portions thereof in the rotor circumferential direction, and an outer periphery supporting shaft configured to engage outer peripheral side torque receiving surfaces provided on the respective back plates at positions outside of the respective linings in the rotor radial direction and intermediate portions in the rotor circumferential direction.

In the disc brake device disclosed in the above-described document, as illustrated in FIG. 12, an outer periphery supporting shaft 70 includes an inner-side outer periphery supporting shaft 62 and an outer-side outer periphery supporting shaft 72. The outer periphery supporting shaft 70 is integrally connected by the engagement between a male screw portion 74 provided at a distal end portion of the inner-side outer periphery supporting shaft 62 and a female screw portion 73 provided at a distal end portion of the outer-side outer periphery supporting shaft 72, and is prevented from coming apart from a supporting portion 27 of an inner housing portion 21 of a caliper 20 and a supporting portion 28 of an outer housing portion 22. Therefore, in the disc brake device of the related art described above, further improvement is required in terms of easiness of assembly and in terms of a cost.

### SUMMARY

In order to achieve the requirement described above, it is an object of the invention to provide a disc brake device which is easy to assemble at a low cost by using a simple configuration for preventing a supporting shaft of the disc brake device from coming apart.

In order to achieve the above-described requirement, the invention provides a disc brake device including: a disc rotor assembled to a rotating body and configured to rotate integrally with the rotating body; a caliper assembled to a supporting member so as to straddle an outer periphery of part of the disc rotor; a pair of brake pads disposed so as to be capable of clamping the disc rotor; pistons disposed in the caliper and configured to press the respective brake pads toward the disc rotor, a supporting shaft inserted into a supporting portion provided on the caliper and configured to support the respective brake pads so as to be movable in a rotor axis direction; and a retaining member inserted into a through hole provided at one end of the supporting shaft and configured to prevent the supporting shaft from coming apart from the supporting portion of the caliper, wherein the retaining member includes a head portion configured to engage with one of opening portions of the through holes, and a pair of leg portions to be inserted into the through hole, and wherein at least one of a pair of the leg portions has a barb shape by being bent for engaging with the other opening portion of the through hole.

According to the disc brake device of the invention, the supporting shaft is prevented from coming apart from a caliper supporting portion by the retaining member which is inserted into the through hole provided at one end thereof. The retaining member engages with the opening portion of the through hole by the head portion and the barb shape formed on at least one of a pair of the leg portions. Therefore, screws or adhesion are not necessary for retaining the supporting shaft. Accordingly, mounting and demounting property at the time of assembly is improved, and simultaneously, a more simple structure is achieved at less cost in comparison with a prior structure on the basis of engagement between a male screw portion and a female screw portion.

### BRIEF DESCRIPTION OF THE DRAWING FIGURES

FIG. 1 is a perspective view of a disc brake device of the invention according to a first embodiment;

FIG. 2 is a cross-sectional view of the disc brake device illustrated in FIG. 1 taken in the rotor circumferential direction when viewing from an outer side toward an inner side;

FIG. 3 is a cross-sectional view of the disc brake device illustrated in FIG. 1 taken in the rotor circumferential direction when viewing from the inner side toward the outer side;

FIG. 4 is a cross-sectional view of the disc brake device in FIG. 1 taken along respective supporting shafts in the rotor axis direction;

FIG. 5 is a cross-sectional view of the disc brake device in FIG. 1 taken along pistons in the rotor axis direction;

FIG. 6 is a perspective view illustrating a state in which a caliper of the disc brake device illustrated in FIG. 1 is demounted;

FIG. 7 is a partial enlarged view of a retaining member and an outer periphery supporting shaft used in the disc brake device illustrated in FIG. 1;

FIG. 8 is a partial cross-sectional view of the retaining member and the outer periphery supporting shaft used in the disc brake device illustrated in FIG. 1;

FIG. 9 illustrates second and third examples of the retaining member and the caliper used in the disc brake device illustrated in FIG. 1;

FIG. 10 illustrates a fourth example of the retaining member used in the disc brake device illustrated in FIG. 1;

FIG. 11 illustrates a fifth example of the retaining member used in the disc brake device illustrated in FIGS. 1; and

FIG. 12 is a cross-sectional view of a disc brake device of the related art taken along the rotor axis direction.

### DETAILED DESCRIPTION

Referring now to the drawings, embodiments of the invention will be described. Although the detailed description will be given on the basis of the embodiments of the invention, the invention is not limited by the embodiments described below to an extent it does not depart from the gist of the invention.

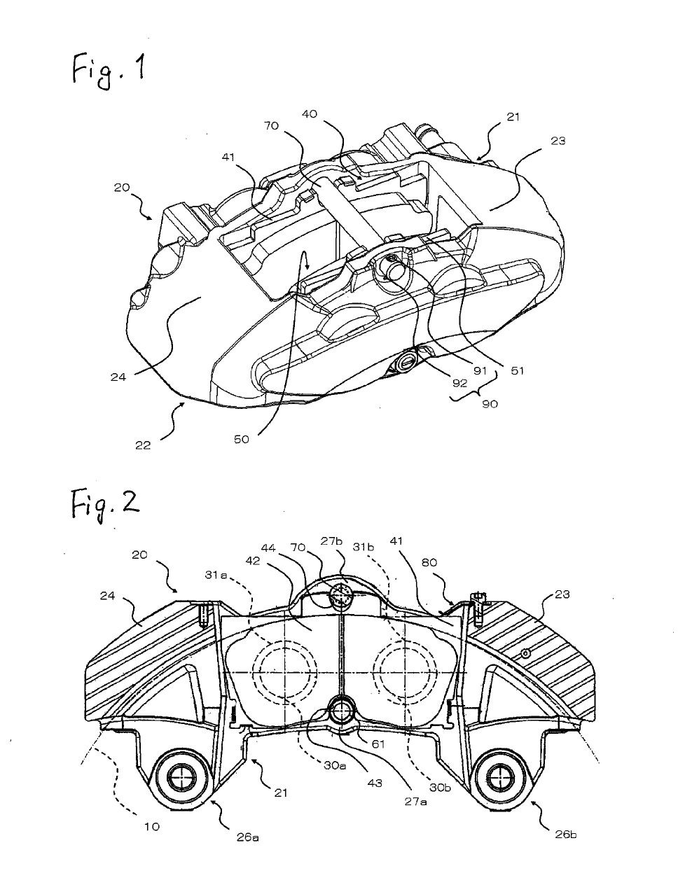

FIG. 1 to FIG. 8 illustrates an embodiment of the present invention. A disc brake device of this embodiment includes: a disc rotor 10 assembled to an axle hub (a rotating body which is not illustrated) and configured to rotate integrally with a wheel (not illustrated); a caliper 20 arranged so as to straddle part of an outer peripheral portion of the disc rotor 10; four pistons 30a, 30b, 30c and 30d disposed in the caliper 20, an inner-side brake pad 40, and an outer brake pad 50; an inner shim IS (see FIG. 6) assembled to the inner-side brake pad 40; and an outer shim OS (see FIG. 6) assembled to the outer brake pad 50. The disc brake device also includes an inner-side inner periphery supporting shaft 61, an outer-side inner periphery supporting shaft 71, an outer periphery supporting shaft 70 provided on the caliper 20, and a leaf spring 80.

The disc rotor 10 includes ring-shaped braking surfaces 11 and 12 which can be clamped by a lining 42 of the inner-side brake pad 40 and a lining 52 of the outer brake pad 50 as illustrated in FIG. 4. The rotation of the disc rotor 10 is braked by the braking surfaces 11 and 12 being clamped between the lining 42 of the inner-side brake pad 40 and the lining 52 of the outer brake pad 50. The disc rotor 10 rotates clockwise (forward rotation) in FIG. 2 integrally with the wheel when the wheel rotates forward, so that the left side in FIG. 2 corresponds to a leading side and the right side in FIG. 2 corresponds to a trailing side.

The caliper 20 includes an inner housing portion 21 and an outer housing portion 22 opposing each other so as to straddle part of the outer periphery of the disc rotor 10 and a pair of coupling portions 23 and 24 coupling the inner housing portion 21 and the outer housing portion 22 as illustrated in FIG. 1 to FIG. 5. The inner housing portion 21 is arranged on the inner side of the disc rotor 10, and includes a pair of cylinders 31a and 31b (See FIG. 2).

The inner housing portion 21 includes a supporting portion 27a configured to support the inner-side inner periphery supporting shaft 61 that engages with a V-shaped inner peripheral side torque receiving surface 43 (see FIG. 2 and FIG. 4) provided on a back plate 41 of the inner-side brake pad 40 at a position inside in the rotor radial direction and at a center portion in the rotor circumferential direction and includes a supporting portion 27b configured to support the outer periphery supporting shaft 70 that engages with a V-shaped outer peripheral side torque receiving surface 44 (see FIG. 2 and FIG. 4) provided on the back plate 41 of the inner-side brake pad 40 at a position inside in the rotor radial direction and at a center portion in the rotor circumferential direction.

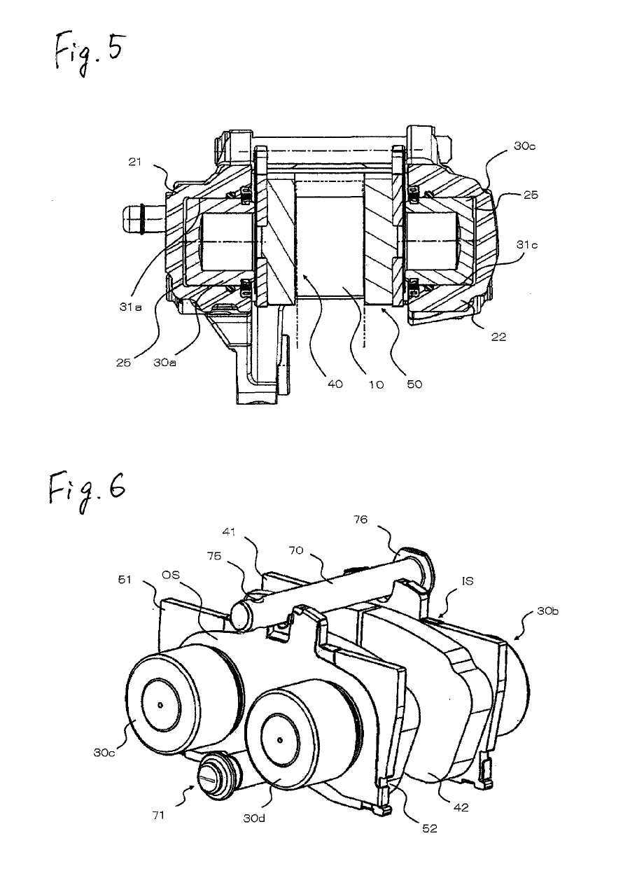

The inner housing portion 21 includes a pair of mounting portions 26a and 26b extending radially inward of the rotor at its inner end in the radial direction of rotor, and is configured to be mounted to the mounting portions 26a and 26b on a vehicle body side (supporting member) by using a bolt (not illustrated). A pair of the cylinders 31a and 31b are arranged at a predetermined distance in the rotor circumferential direction as illustrated in FIG. 2, and is formed in the rotor axis direction as illustrated in FIG. 5.

The outer housing portion 22 is arranged on the outer side of the disc rotor 10, includes a pair of cylinders 31c and 31d in the same manner as the cylinders 31a and 31b of the inner housing portion 21, and a supporting portion 28a configured to support the outer-side inner periphery supporting shaft 71 and a supporting portion 28b configured to support the outer periphery supporting shaft 70 in the same manner as the supporting portions 27a and 27b of the inner housing portion 21.

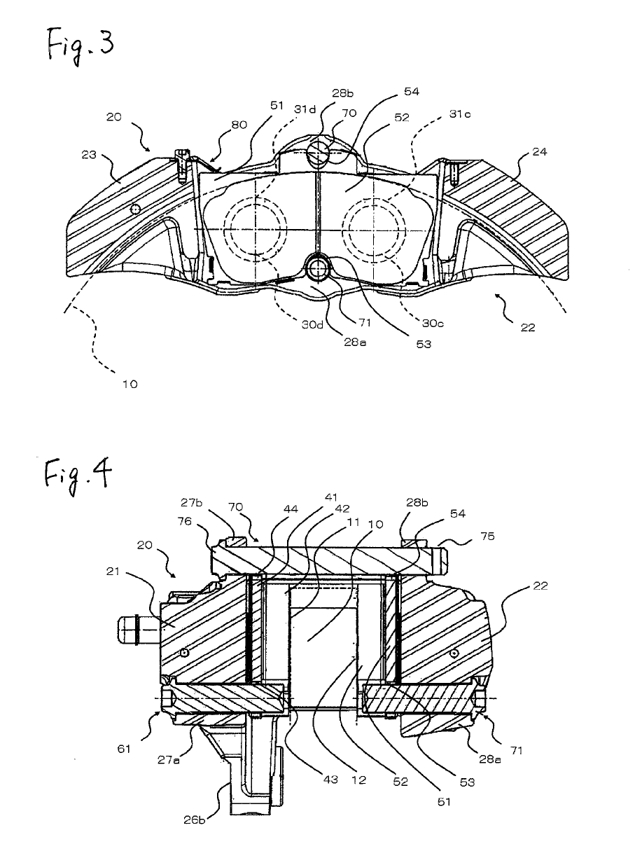

The pistons 30a, 30b, 30c, and 30d are assembled to the cylinders 31a, 31b, 31c, and 31d respectively in a liquid tight manner so as to be slidable in the rotor axis direction as publicly known and are arranged so as to oppose each other with the disc rotor 10 interposed therebetween as illustrated in FIG. 2, FIG. 3, and FIG. 5. The pistons 30a, 30b, 30c, and 30d are moved by being pushed by operating fluid supplied to fluid chambers 25 (see FIG. 5) defined with the respective cylinders 31a, 31b, 31c and 31d from a brake master cylinder (not illustrated) when putting a brake on the disc rotor 10, so that the inner-side brake pad 40 and the outer brake pad 50 can be pressed toward the disc rotor 10 in the rotor axis direction. The respective fluid chambers 25 communicate with each other. The leaf spring 80 is assembled to the caliper 20, and biases the inner-side brake pad 40 and the outer brake pad 50 inward of the rotor axial direction.

The inner-side brake pad 40 includes the back plate 41, and the lining 42 secured to the back plate 41 as illustrated in FIG. 2 and FIG. 4. The inner-side brake pad 40 is disposed on the inner housing portion 21 side of the caliper 20 and is assembled to the inner-side inner periphery supporting shaft 61 and the outer periphery supporting shaft 70 with the back plate 41 as illustrated in FIG. 1, FIG. 2, and FIG. 4.

The back plate 41 is formed into a plate shape, and includes the inner peripheral side torque receiving surface 43 and the outer peripheral side torque receiving surface 44 as illustrated in FIG. 2 and FIG. 4. The inner peripheral side torque receiving surface 43 is provided inside in the rotor radial direction and at a center in the rotor circumferential direction of the lining 42, and the outer peripheral side torque receiving surface 44 is provided outside in the rotor radial direction and at a center portion in the rotor circumferential direction of the lining 42.

The lining 42, being formed so as to extend in substantially a fan shape in the rotor circumferential direction, comes into press contact with the braking surface 11 of the disc rotor 10 so as to be slidable and puts a brake on the disc rotor 10 by the movement of the pistons 30a and 30b pressing the back plate 41. At the time when the disc rotor 10 in forward rotation is braked (when the disc rotor is braked when the vehicle is moving forward), a frictional force acts on the lining 42 in press contact with the braking surface 11 of the disc rotor 10 so as to be slidable from the leading side to the trailing side in the rotor circumferential direction.

The outer brake pad 50 includes a back plate 51 and the lining 52 secured to the back plate 51 as illustrated in FIG. 3 and FIG. 4. The outer brake pad 50 is disposed on the outer housing portion 22 side of the caliper 20, and is assembled to the outer-side inner periphery supporting shaft 71 and the outer periphery supporting shaft 70 by the back plate 51 as illustrated in FIG. 1, FIG. 3, and FIG. 4.

The back plate 51 is formed into a plate shape as illustrated in FIG. 3 and FIG. 4, and includes an inner peripheral side torque receiving surface 53 and an outer peripheral side torque receiving surface 54. The inner peripheral side torque receiving surface 53 is provided inside the lining 52 in the rotor radial direction and at the center thereof in the rotor circumferential direction, and the outer peripheral side torque receiving surface 54 is provided outside the lining 52 in the rotor radial direction and at the center portion thereof in the rotor circumferential direction.

The lining 52, being formed so as to extend in substantially a fan shape in the rotor circumferential direction, comes into press contact with the surface to be braked 12 of the disc rotor 10 so as to be slidable and puts a brake on the disc rotor 10 by the movement of the pistons 30c and 30d pressing the back plate 51. At the time when the disc rotor 10 in forward rotation is braked (when the disc rotor is braked when the vehicle is moving forward), a frictional force acts on the lining 52 in press contact with the surface to be braked 12 of the disc rotor 10 so as to be slidable from the leading side to the trailing side in the rotor circumferential direction.

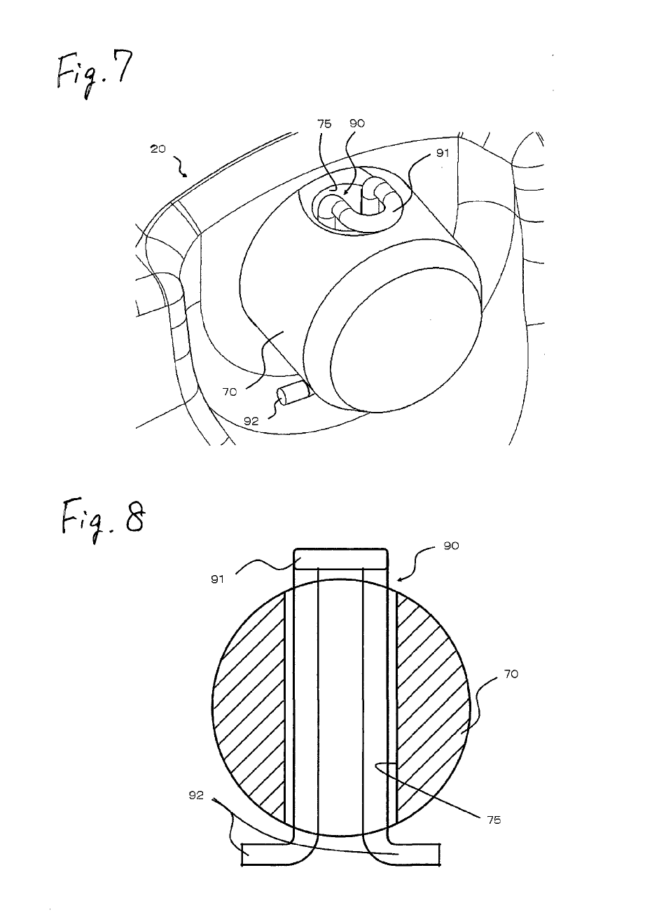

The inner-side inner periphery supporting shaft 61 and the outer-side inner periphery supporting shaft 71 are supported on the respective supporting portions 27a and 28a of the caliper 20, and extends in the rotor axis direction as illustrated in FIG. 4. The outer periphery supporting shaft 70 includes a through hole 75 at an end on the outer housing portion 22 side and includes a flange portion 76 at an end on the inner housing portion 21 side (see FIG. 4 and FIG. 6). As illustrated in FIG. 1, FIG. 7 and FIG. 8, a retaining member 90 is inserted into the through hole 75 of the outer periphery supporting shaft 70. The retaining member 90 includes a head portion 91 and a pair of leg portions 92. The head portion 91 engages with an opening of the through hole 75. The pair of the leg portions 92 is inserted into the through hole 75 and is bent so that the distance between distal ends thereof becomes larger than the diameter of the through hole 75 in a state in which no load is applied. The outer periphery supporting shaft 70 is retained so as not to come apart from the supporting portions 27b and 28b of the caliper 20 by the retaining member 90 and the flange portion 76 inserted into the through hole 75.

In this embodiment configured as described above, when the brake pads 40 and 50 are assembled to the caliper 20, assembly is completed by installing the brake pads 40 and 50 on the inner periphery supporting shafts 61 and 71 respectively, inserting the outer periphery supporting shaft 70 onto the supporting portions 27b and 28b (see FIG. 4) of the caliper 20 from one end side provided with the through hole 75, engaging the outer periphery supporting shaft 70 with the outer peripheral side torque receiving surfaces 44 and 54 provided respectively on the back plates 41 and 51 on the outside of the respective linings 42 and 52 in the rotor radial direction and at the center portions thereof in the rotor circumferential direction, and inserting the retaining member 90 in the through hole 75.

When inserting the retaining member 90 into the through hole 75, the pair of the leg portions 92 is pinched to reduce the distance between the distal end portions to be smaller than the diameter of the through hole 75 before insertion. After the insertion, the head portion 91 engages with the through hole 75, the pair of the leg portions 92 is restored by a resilient force thereof into a state in which the distal end portions thereof are opened to have a distance larger than the diameter of the through hole 75 to form a barb shape with respect to the through hole 75. In this manner, the retaining member 90 has a structure (barb shape) resisting a force in a direction of being pulled out from the through hole 75 inserted once into the through hole 75. In addition, the head portion 91 engages with the opening of the through hole 75 without passing through the through hole 75, so that fixation of the retaining member 90 with respect to the outer periphery supporting shaft 70 is achieved.

When the fixation of the retaining member 90 is completed, the retaining member 90 is prevented from coming off easily against the force applied in the direction of being pulled out from the through hole 75 by the engagement of the head portion 91 and the barb shape of the leg portions 92. Therefore, useless dropping of the retaining member 90 and the outer periphery supporting shaft 70 at the time of assembly, or service, maintenance, and the like of the disc brake device is prevented.

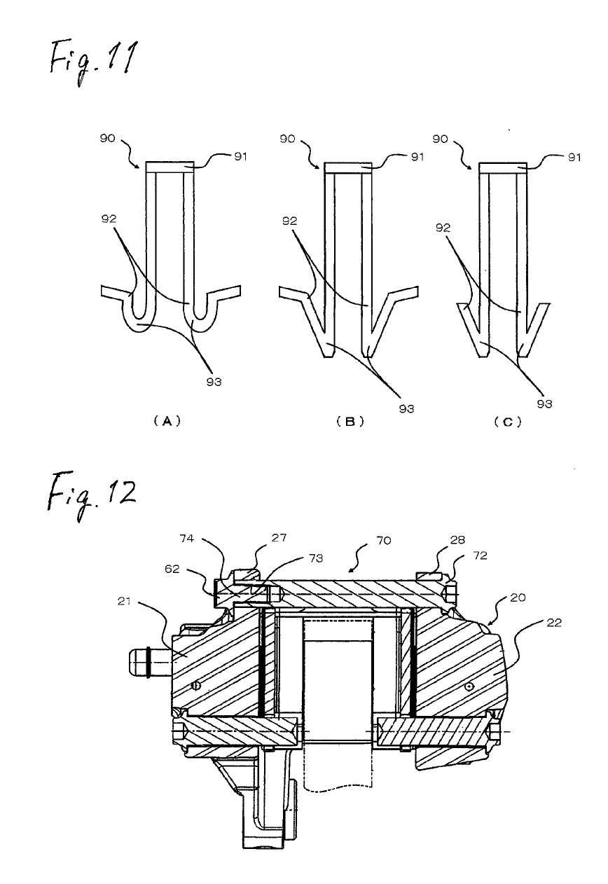

When the outer periphery supporting shaft 70 is demounted for service, maintenance, and the like of the disc brake device, the retaining member 90 can be pulled out while maintaining the shape of the retaining member 90 by holding or pinching the pair of the leg portions 92 of the retaining member 90 and pulling the head portion 91 in a state in which the distance between the distal end portions is reduced to a length smaller than the diameter of the through hole 75, so that the reuse of the retaining member 90 is enabled. As described above, according to this embodiment, mounting and demounting property at the time of assembly can be improved, and a simple structure at a low cost is achieved in comparison with a prior structure on the basis of engagement between the male screw portion 74 and the female screw portion 73 as is seen in the outer periphery supporting shaft 70 of the related art illustrated in FIG. 12.

### Other Embodiments

Referring to FIG. 9 (A) and (B), second and third examples of the retaining member 90 and the caliper 20 of the embodiment will be described. As illustrated in FIG. 9 (A) and (B), the second and third examples have a structure in which distal end portions of the pair of the leg portions 92 engage with the caliper 20 in which the retaining member 90 is inserted into the through hole 75. More specifically, in the second example illustrated in FIG. 9 (A), the distal end portions of the pair of the leg portions 92 is extended in comparison with the example described above (see FIG. 7), and is formed so as to engage with a wall surface of the caliper 20. In the third example illustrated in FIG. 9 (B), the wall surface of the caliper 20 is formed to be a depressed shape so as to engage with the pair of the leg portions 92 of the retaining member 90.

In the disc brake device, the outer periphery supporting shaft 70 is rotated about an axial center by a force or vibrations generating when a brake is put on the vehicle. When the outer periphery supporting shaft 70 is rotated, positions where the outer peripheral side torque receiving surfaces 44 and 54 contact change. Therefore, the leg portions 92 are caused to engage with he wall surface of the caliper 20 by means of extending the leg portions 92 of the retaining member 90 or notching the wall surface of the caliper 20 around the outer periphery supporting shaft 70, or both. Accordingly, the retaining member 90 acts repulsively against a rotational force applied to the outer periphery supporting shaft 70, and holds the outer periphery supporting shaft 70 at a predetermined position.

The position of the outer periphery supporting shaft 70 is maintained by the retaining member 90, and hence the rotation is restricted, so that the position of the back plates 41 and 51 of the brake pads 40 and 50 contacting against the outer periphery supporting shaft 70 can be fixed. In this manner, in the second and the third examples, the distal end portions of the leg portions 92 engage with the caliper 20, so that the outer periphery supporting shaft 70 is prevented from rotating in the supporting portions 27b and 28b (see FIG. 4) of the caliper 20 about the axial center thereof due to the movements of the brake pads 40 and 50 or the vibrations of the vehicle at the time of braking. Therefore, the outer periphery supporting shaft 70 can receive a torque at the time of braking stably. Therefore, in order to further reduce the weight of the caliper 20, cutting of the outer periphery supporting shaft 70 except for surfaces of contact with the back plates 41 and 51 or application of specific coating material (coating material having an effect of reducing friction, for example) on the outer periphery supporting shaft 70 over an effective range are enabled.

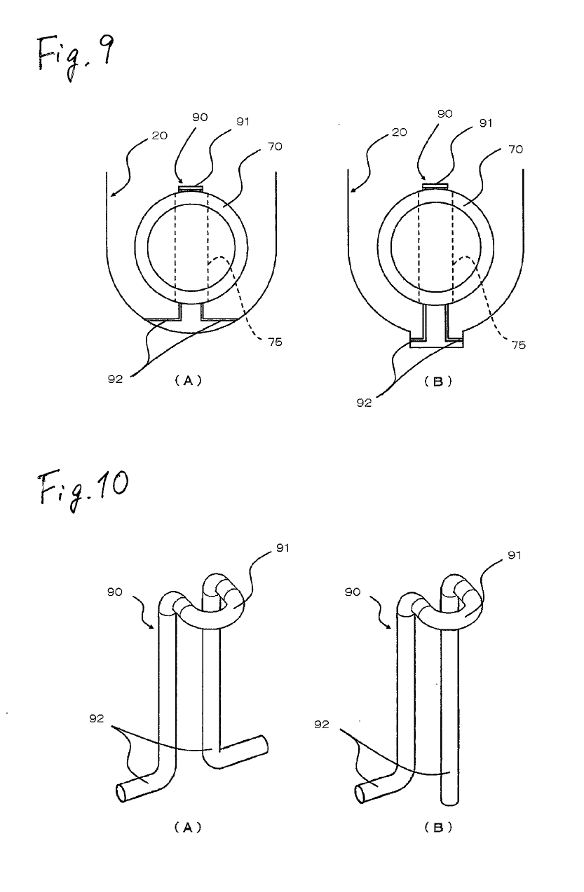

Referring now to FIG. 10 (A) and (B), a fourth example of the retaining member 90 in the embodiment will be described. In the fourth example illustrated in FIG. 10 (B), only one of the pair of the leg portions 92 is bent and has a barb shape in comparison with the examples described above (see FIG. 10 (A)). In the case where only one of the leg portions 92 has a barb shape, the straight leg portion 92 having no barb plays a role of a guide when inserting the pair of the leg portions 92 into the through hole 75, so that an easy-to-assembly shape is achieved.

Referring now to FIG. 11 (A) to (C), the retaining member 90 according to a fifth example of the embodiment will be described. In the fifth example illustrated in FIG. 11 (A) to (C), the retaining member 90 includes guide strips 93 on the leg portions 92. The guide strips 93 are formed by curving or bending part of the leg portions 92. The guide strips 93 have a shape which is resiliently deformed when inserting the retaining member 90, and is restored after the insertion.

In the case of insertion of a retaining member 90 into the through hole 75, in the case of the retaining member 90 having the shapes as illustrated in FIG. 11 (A) to (C), the guide strips 93 are placed at the through hole 75 without pinching the leg portions 92 and the head portion 91 is pressed, so that the guide strips 93 are resiliently deformed and are inserted into the through hole 75. After the insertion, the leg portions 92 engage the through hole 75 by the resilient force of the guide strips 93. Accordingly, insertion of the retaining member 90 into the through hole 75 is facilitated, and time required for assembly may be reduced.

The head portion 91 of the retaining member 90 of the embodiment may have a shape that engages the through hole 75. For example, a configuration in which the head portion 91 has a substantially circular shape extending in the rotor radial direction, the diameter of the circle is larger than the diameter of the through hole 75, so that the retaining member 90 cannot be pulled out easily when being pulled from the leg portions 92 is also applicable.

In this embodiment, the outer periphery supporting shaft 70 is illustrated as being formed of a single member. However, a configuration in which the inner-side outer periphery supporting shaft and the outer-side outer periphery supporting shaft are integrally coupled by screwing coupling is applicable, or alternatively, a configuration in which these shafts are provided separately is also applicable. The caliper 20 implemented in the embodiment includes the inner housing portion 21 and the outer housing portion 22 opposing each other so as to straddle part of the outer peripheral portion of the disc rotor 10, and the pair of coupling portions 23 and 24 configured to couple the housing portions 21 and 22 and these members are formed integrally. However, the invention may be implemented by employing the caliper 20 in which the inner housing portion 21 and the outer housing portion 22 of the caliper 20 are divided into two parts in the rotor axis direction, and these parts are coupled with a plurality of bolts.

In the embodiment, the inner housing portion 21 and the outer housing portion 22 of the caliper 20 include two each of the pistons 30a, 30b, 30c, and 30d and the cylinders 31a, 31b, 31c, and 31d. However, the number of the cylinders formed on the inner housing portion 21 and the outer housing portion 22 of the caliper 20 and the pistons to be assembled thereto may be one or three or more, respectively.

The outer periphery supporting shaft 70 of the embodiment is implemented by arranging the through hole 75 on the outer side of the caliper 20 and the flange portion 76 on the inner side of the caliper 20. However, a structure of the outer periphery supporting shaft 70 in which the flange portion 76 is arranged on the outer side of the caliper 20 and the through hole 75 on the inner side thereof is also applicable.

The disc brake device of the embodiment employs a configuration in which the single outer periphery supporting shaft 70 is arranged outside of the caliper 20 in the rotor radial direction at the center portion thereof in the rotor circumferential direction. However, a configuration in which a pair of the outer periphery supporting shafts arranged at a predetermined interval in the rotor circumferential direction outside of the caliper 20 in the rotor radial direction with the center portion thereof in the rotor circumferential direction interposed therebetween is also applicable.

What is claimed is:

1. A disc brake device comprising:
a disc rotor assembled to a rotating body and configured to rotate integrally with the rotating body;
a caliper assembled to a supporting member so as to straddle an outer periphery of part of the disc rotor;
a pair of brake pads disposed so as to clamp the disc rotor;
pistons disposed in the caliper and configured to press the respective brake pads toward the disc rotor,
a supporting shaft inserted into a supporting portion provided on the caliper and configured to support the respective brake pads so as to be movable in a rotor axis direction; and
a retaining member inserted into a through hole provided at one end of the supporting shaft and configured to prevent the supporting shaft from coming apart from the supporting portion of the caliper,
wherein the retaining member includes a head portion configured to engage with one of opening portions of the through holes, and a pair of leg portions to be inserted into the through hole, and
wherein at least one of a pair of the leg portions is bent and has a barb shape configured to engage with the other opening portion of the through hole.

2. The disc brake device according to claim 1, wherein the supporting shaft includes an inner periphery supporting shaft configured to engage with an inner peripheral side torque receiving surface provided inside of the brake pads in the rotor radial direction at a center portion thereof in the rotor circumferential direction, an outer periphery supporting shaft configured to engage with an outer peripheral side torque receiving surface provided outside of the brake pads in the rotor radial direction at a center portion thereof in the rotor circumferential direction, and the outer periphery supporting shaft is prevented from coming apart from the supporting portion of the caliper by the retaining member inserted into the through hole provided at one end thereof and a flange portion provided at the other end thereof.

3. The disc brake device according to claim 1, wherein in a state in which the retaining member is inserted into the through hole, distal end portions of the leg portions engage with the caliper.

4. The disc brake device according to claim 2, wherein in a state in which the retaining member is inserted into the through hole, distal end portions of the leg portions engage with the caliper.
